(19) United States
(12) Patent Application Publication
(10) Pub. No.: US 2008/0223536 A1
(43) Pub. Date: Sep. 18, 2008

(54) Paper Comprising Quaternary Nitrogen Containing Cellulose Ether

(75) Inventor: Peter Marten Van Der Horst, Arnhem (NL)

Correspondence Address: AKZO NOBEL INC., LEGAL & IP, 120 WHITE PLAINS ROAD, SUITE 300, TARRYTOWN, NY, 10591, US

(73) Assignee: ANZO NOBEL N.V., Arnhem (NL)

(21) Appl. No.: 10/584,005

(22) PCT Filed: Dec. 21, 2004
(86) PCT No.: PCT/EP2004/014737

§ 371 Date: Aug. 15, 2006

Related U.S. Application Data
(60) Provisional application No. 60/544,342, filed on Feb. 17, 2004.

(30) Foreign Application Priority Data
Dec. 22, 2003 (EP) 03078994.5

(51) Int. Cl. D21H 17/26; C08B 11/14

(52) U.S. Cl. 162/177; 536/43

(57) ABSTRACT

The invention relates to paper comprising a filler and a cellulose ether wherein the cellulose ether comprises a quaternary ammonium group, with the proviso that the cellulose ether is not a hydroxyethyl cellulose.

The invention relates to paper comprising cellulose ether. The invention further relates to the use of cellulose ether in papermaking processes.

Generally, papermaking processes comprise the steps of forming a paper web from an aqueous stock comprising cellulosic fibres, optionally fillers and additives, by feeding the stock to a forming wire and removing water therefrom. The next steps are to further remove water by pressing and then by drying.

The term “paper” refers to sheet- or web-like products of the process including board, cardboard, and pulp sheets. Examples of paper are tissue paper and paper toweling, newsprint, grocery bags, fine papers, kraft linerboard, and folding boxboards. Paper has certain physical and chemical properties which, depending on its use, are known to the person skilled in the art. These properties can be varied by adding filler and/or additives to the stock. It is also possible to change the chemical and/or physical properties of paper by for example adding a paper coating on one or both sides of a (base) paper sheet, which is normally done in a size press or coater in the drying section of the paper machine or in a coater off-line of the paper machine. A wide range of additives can be added in the papermaking process. Apart from changing the chemical and physical properties of the paper, such additives may also serve to aid the papermaking process itself, as is known to the skilled person.

An example of an additive which has already been used in papermaking processes for many years is carboxymethyl cellulose (CMC). CMC is used as a dry-strength additive for improving the strength of the final paper product. In paper coatings CMC is used as a water-retention aid, so as to prevent premature dewatering of the paper coating after it has been applied to the paper but before the paper has been finally dried. Conventional CMC only has a limited functionality and due to its anionic character may decrease the efficiency of cationic additives in the stock. As a consequence, the use of CMC in wet-end applications of the papermaking processes is limited, or it can only be used in combination with fixation agents such as alum.

It is therefore an object of the present invention to provide a modified cellulose ether for use in papermaking processes which does not have the above-mentioned problems.

This object is achieved with a paper comprising a filler and a cellulose ether comprising a quaternary ammonium group, with the proviso that the cellulose ether is not a hydroxyethyl cellulose.

Preferably, the quaternary ammonium group is of the formula:

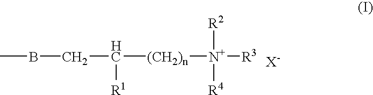

wherein R¹ is H or OH, R², R³ and R⁴ are the same or different and are selected from C₁-C₂₄ alkyl, C₆-C₂₄ aryl, C₇-C₂₄ aralkyl, C₇-C₂₄ alkaryl, C₃-C₂₄ cycloalkyl, C₂-C₂₄ alkoxyalkyl, and C₇-C₂₄ alkoxyaryl groups, or R², R³, R⁴, and the quaternary nitrogen atom form an aliphatic or aromatic heterocyclic ring; n is an integer of 1 to 4, B is attached to the cellulose backbone of the cellulose ether and selected from O, OC(O), C(O)O, C(O)—NH, NHC(O), S, OSO₃, OPO₃, NH, or NR⁵, wherein R⁵ is a C₂-C₆ acyl or a C₁-C₄ alkyl radical, and X⁻ is an anion. Preferably, B is O. It is further preferred that R², R³, and R⁴ are independently selected from the group consisting of methyl, ethyl, propyl, and benzyl.

By using a cellulose ether comprising a quaternary ammonium group according to the invention, paper can be manufactured with a lower dewatering time in the forming wire section compared to conventional CMC.

This lower dewatering time enables a higher productivity of the papermaking machine, particularly in those processes where the dewatering step is the flow- or speed-limiting step. Moreover, if a filler is added to the stock, more filler is retained in the water removal steps and consequently a higher filler content in the paper is possible. As the filler is generally cheaper than the cellulosic fibre, highly filled paper can be produced in an economically more attractive way. Not being bound by theory, we believe that the higher affinity (or better adsorption) of the cellulose ether for the filler causes flocculation of fine (filler or fibre) particles present in the stock, resulting in a better retention of filler during the water removal steps.

The cellulose ether according to the invention may have a wider range of functions within the papermaking process and the resulting paper compared to conventionally used non-substituted CMC. It was found that the cellulose ether according to the invention adsorbs better than conventional CMC onto other compounds present in the stock, such as the cellulosic fibre or the filler, for example. Moreover, less of the cellulose ether having a quaternary ammonium group will remain non-adsorbed in the stock, which is advantageous for the process as, in particular, non-adsorbed cellulose ether will decrease the efficiency of cationic compounds in the stock. This will also result in a diminished build-up of cellulose ether in the white water (i.e. water which is mechanically drained from the stock), which is advantageous, since white water is generally re-used in the papermaking process. Moreover, the amount of filler retained in the paper is also higher compared to the use of conventional CMC.

The chemical structure of the cellulose ether of the invention is similar to that of the cellulosic fibre. This will not only give the resulting paper a good dry strength, but will also lead to a better recyclability of the paper after use. The paper to be recycled contains less non-cellulosic material and thus will have a better quality. Moreover, essentially all of the cellulose ether of the invention will remain adsorbed during repulping of the paper, giving the same advantages during the recycling process as during the initial papermaking process, as indicated above.

The cellulose ether of the invention is not a hydroxyethyl cellulose. Use of a hydroxyethyl cellulose comprising a quaternary ammonium group in paper is known from GB 1,474,551. Such a hydroxyethyl cellulose (HEC) is a strong flocculation agent causing the formation of cellulose agglomerates originating from the pulp, which in turn leads to visibly inhomogeneous paper, which is undesirable. Furthermore, the HEC described in GB 1,474,551 causes the paper to have a higher dewatering time, which is detrimental to the productivity of the paper making process. It is further noted that this type of HEC is relatively expensive compared to, e.g., carboxymethyl cellulose comprising a quaternary ammonium group in accordance with the invention.

The cellulose ethers according to the invention generally have a degree of substitution (also referred to as DS) of quaternary ammonium groups of at least 0.01, preferably at least 0.02, and most preferably at least 0.05, and of at most 1.0, preferably at most 0.5, and most preferably at most 0.35. The cellulose ether may have only quaternary ammonium groups substituted onto the cellulose backbone. It may also be desirable to introduce other substituents onto the cellulose backbone or onto other reactive hydroxyl groups of the cellulose ether. Preferably, these substituents will be anionic or non-ionic. Examples of anionic groups are carboxyalkyl, sulphonate (e.g. sulphoethyl), phosphate, and phosphonate groups. Of the anionic groups carboxyalkyl and in particular carboxymethyl are most preferred. Generally, the average DS of carboxymethyl groups is at least 0.05, preferably at least 0.1, more preferably at least 0.15, and most preferably at least 0.2, and at most 1.2, preferably at most 1.0, more preferably at most 0.8, and most preferably at most 0.6. A cellulose ether comprising both a quaternary ammonium group and an anionic group generally has the advantage of being able to both disperse and flocculate the fibre and/or the filler.

Additionally or alternatively, nonionic groups can be introduced in order to improve the hydrophobic-hydrophilic balance of the cellulose ether or to improve its water solubility. Any nonionic group known to the skilled person can be incorporated. Examples can be gleaned from EP 0 991 668, which is incorporated herein by reference.

Depending on their functional use and the DS level of quaternary ammonium groups, cellulose ethers of the invention having a low DS of carboxymethyl groups, i.e. having fewer anionic groups, are preferred. Preferably, the net charge on the cellulose ether is at least −0.7, preferably at least −0.5, most preferably at least −0.4. The net charge is defined as the subtraction of the average DS of carboxymethyl groups from the average DS of quaternary ammonium groups.

Generally, the molecular weight of the cellulose ether of the invention is at least 20,000 Dalton, preferably at least 35,000 Dalton, and most preferably at least 50,000 Dalton, and at most 2,000,000 Dalton, preferably at most 1,200,000 Dalton, and most preferably at most 800,000 Dalton.

The quaternary ammonium-containing cellulose ether according to the invention can be prepared by any suitable method known to the person skilled in the art. Suitable methods can for example be found in U.S. Pat. No. 6,281,172, which is incorporated herein by reference.

Generally, the amount of cellulose ether of the invention in paper is at least 0.05 kg/ton, preferably at least 0.1 kg/ton, and at most 2.0 kg/ton, and preferably at most 0.8 kg/ton.

The cellulose ether of the invention can be used in any type of paper comprising a filler. The filler used in paper can be any filler known to the skilled person. Examples of such fillers are kaolin clay, titanium dioxide, calcium carbonate, hydrated alumina, and talc. Kaolin clay and calcium carbonate are the preferred filler materials.

Generally, the amount of filler used in the paper of the invention is at least 0.01 percent by weight (wt %), preferably at least 1 wt %, and most preferably at least 2 wt %, based on the total weight of the paper, and at most 50 wt %, preferably at most 45 wt %, and most preferably at most 40 wt %, based on the total weight of the paper. Because the cellulose ether of the invention results in an improved retention of the filler material in the papermaking process, the cellulose ether is particularly suitable for use in paper having a filler content of above 20 wt %, preferably above 25 wt %, based on the total weight of the paper.

The cellulose ether of the invention can be added to the stock having varying functionality. For example, it may serve as a retention aid, a drainage or dewatering aid, a wet-web strength additive, a pitch-control agent, a sizing agent, a dry-strength additive, or as a wet-strength additive. The cellulose ether can be used alone or in combination with other additives so as to obtain or enhance a certain functionality in the papermaking process. The cellulose ether of the invention may also be used in paper coating, for example as a surface sizing agent, a dry-strength additive, a rheology additive, or as a water-retention aid.

The cellulose ether according to the invention may be used alone or in combination with conventional additives. Examples of conventional additives can be found in Kirk-Othmer Encyclopedia of Chemical Technology, John Wiley & Sons, Inc. 1996 (online posting date of Dec. 4, 2000) on “Papermaking Additives” by M. A. Dulaney et al., and in “Paper Chemistry” by D. Eklund and T. Lindström, 1991, DT Paper Science Publications, Grankulla, Finland.

The invention is illustrated by the following examples.

Experimental

Apart from water and cellulosic fibres, hemicellulose, lignin and wood resins (released at pulping and bleaching) such as lipophilic extractives (fatty and resin acids, sterols, steryl esters, triglycerides), the stock comprises also fats, terpenes, terpeniods, waxes, etc. Fillers are often added, and there are salts present, as well as different chemical additives. If recycled fibre is used as a raw material, also compounds such as inks, glues, hot-melt plastics, latex, etc. are present.

In the paper machine wet-end, thick stock is mixed and usually diluted by process water such as white water to become thin stock. The thin stock is fed to the paper machine head box and onto the forming wire. The thin stock fibre suspension normally has a consistency of about 0.5 to 1.5% on dry material basis. Water is removed in the wire section to form a wet web at very approximately 20 wt % dry content. In the press section, water is removed further by pressing to a very approximate dry content of 40 wt %. Finally, in the drying section, the paper web is dried to a final dry content of very approximately 90-100%.

The ash content of the paper can be measured on-line, but usually the analysis takes the form of pyrolysis of a paper sample made in the laboratory. Depending on which temperature is used and which type of filler is present, a conversion factor is applied when calculating the filler content. By filler content is meant the pyrolysis residue weight as a percentage of the total weight of the paper sample (i.e. the ash content), times a conversion factor.

### COMPARATIVE EXAMPLE 1

Gabrosa PA 347 (molecular weight 150,000 Dalton) ex Akzo Nobel (a CMC which is not in accordance with the invention) having a DS of carboxymethyl groups of 0.5 is added to the stock in a concentration of 2 kg/t stock. The thus obtained stock was dewatered according to the above method in 6.8 seconds. The filler content of the obtained paper was 34.9 wt %, calculated on total weight of the paper.

### EXAMPLE 1

To the stock a CMC having a DS of carboxymethyl groups of 0.4 and a DS of quaternary ammonium groups of 0.17 was added. This CMC has a molecular weight of about 150,000 Dalton. Dewatering proceeded in 6.5 seconds and the filler content was found to be 35.3 wt %. Compared to conventional CMC, the CMC of this Example showed a shorter dewatering time and a higher filler content.

### EXAMPLE 2

To the stock a CMC having a DS of carboxymethyl groups of 0.4 and a DS of quaternary ammonium groups of 0.17 was added. This CMC has a molecular weight of 800,000 Dalton. Dewatering proceeded in 6.2 seconds and the filler content was found to be 35.8 wt %. Compared to non-substituted CMC, the CMC of this Example showed a shorter dewatering time and a higher filler content.

### EXAMPLE 3

In this Example various CMCs were added to a fine paper furnish. The following CMCs were used:

CMC-C1 is a conventional CMC having a DS of carboxymethyl groups of 0.35 and a molecular weight of 150,000 Dalton. This CMC is not in accordance with the present invention.

CMC-C2, which is Gabrosa PA 347 (molecular weight 150,000 Dalton) ex Akzo Nobel (a CMC which is not in accordance with the invention) having a DS of carboxymethyl groups of 0.5.

CMC-C3, which is FinnFix BW ex Noviant. This CMC (which is not in accordance with the invention) has a molecular weight of 150,000 Dalton and a DS of carboxymethyl groups of 0.57.

CMC-1, which is an amphoteric CMC having a DS of carboxymethyl groups of 0.4 and a DS of quaternary ammonium groups of 0.17, was added. This CMC has a molecular weight of about 150,000 Dalton and is in accordance with the invention.

CMC-2, which is an amphoteric CMC having a DS of carboxymethyl groups of 0.4 and a DS of quaternary ammonium groups of 0.17, was added. This CMC has a molecular weight of 800,000 Dalton and is in accordance with the invention.

Fine paper furnish was prepared from chemical pulp 80/20 (w/w) birch/pine. The furnish suspension contained 40 wt % calcium carbonate filler, had a consistency of 0.5 wt %, pH of 7.8, and conductivity of 1.5 mS/cm. To the pulp suspension were added 2 kg CMC/ton dry material and a retention system containing 6 kg cationic starch/ton dry material and 0.5 kg silica particles (Eka retention silica NP 780)/ton dry material. The addition sequence was the following:

| | |
|---|---|
| addition of starch: | 0 sec |
| addition of CMC: | 15 sec. |
| addition of retention silica: | 40 sec. |
| dewatering: | 45 sec. |

The dewatering measurements were made using a Dynamic Drainage Analyser (Akribi kemikonsulter AB, Sweden). The turbidity was measured by a nephelometer using the unit [NTU], nephelometric turbidity unit.

The values for turbidity and dewatering time are presented in Table 1.

TABLE 1

| | CMC-C1 | CMC-C2 | CMC-C3 | CMC-1 | CMC-2 |
|---|---|---|---|---|---|
| Turbidity (NTU) | 425 | 563 | 734 | 442 | 367 |
| Dewatering time | 6.6 | 6.8 | 7.3 | 6.5 | 6.2 |
| (s) | | | | | |

From Table 1 it can be deduced that CMC-1 and CMC-2 have the lowest dewatering times, and thus render a higher productivity of the papermaking machine.

Table 1 further shows that the papers comprising the CMCs of the invention generally have a lower turbidity value compared to paper comprising conventional CMCs. This means that the amount of filler retained in the paper web is higher for CMC-1 and CMC-2-containing paper.

### EXAMPLE 4

In this Example super calandered (SC) paper furnish was prepared using CMC-C1, CMC-C3, and CMC-1, which are all described in Example 3.

The SC paper furnish used comprised 50 parts by weight of pulp which consisted of 80 wt % mechanical pulp and 20 wt % chemical pulp. The furnish suspension further comprised 50 parts by weight of kaolin clay filler, had a consistency of 0.25 wt %, pH of 7.8, and conductivity of 0.3 mS/cm. To the pulp suspension were added 10 kg CMC/ton dry material and a retention system containing cationic polymer (Eka retention polymer PL 1510) and silica particles (Eka retention silica NP 780). Both the polymer and the silica particles were added in an amount of 1 kg/ton dry fibres. The addition sequence was the following:

| | |
|---|---|
| addition of CMC: | 0 sec |
| addition of retention polymer: | 15 sec. |
| addition of retention silica: | 30 sec. |
| dewatering: | 45 sec. |

The turbidity was measured by a nephelometer using the unit [NTU], nephelometric turbidity unit. The ash retention was measured at 925° C. standard method.

The turbidity and ash retention values are presented in Table 2.

TABLE 2

| | CMC-C1 | CMC-C3 | CMC-1 |
|---|---|---|---|
| Turbidity (NTU) | 107 | 115 | 85 |
| Ash retention (%) | 83.8 | 83.3 | 85.2 |

In the above Table, it is shown that paper comprising CMC-1 has a higher ash content than paper comprising CMC-C1 or CMC-C3, which means that more filler is retained in the paper during the papermaking process. It is further noted that the dry strength of paper comprising CMC-1 is higher than the dry strength of the papers comprising CMC-C1 or CMC

1. A paper comprising a filler and a cellulose ether wherein the cellulose ether comprises a quaternary ammonium group, with the proviso that the cellulose ether is not a hydroxyethyl cellulose.

2. The paper according to claim 1 wherein the quaternary ammonium group is represented by the formula:
(I) 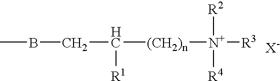
wherein R¹ is H or OH, R², R³, and R⁴ are the same or different and are selected from C₁-C₂₄ alkyl, C₆-C₂₄ aryl, C₇-C₂₄ aralkyl, C₇-C₂₄ alkaryl, C₃-C₂₄ cycloalkyl, C₂-C₂₄ alkoxyalkyl, and C₇-C₂₄ alkoxyaryl groups, or R², R³, R⁴, and the quaternary nitrogen atom form an aliphatic or aromatic heterocyclic ring; n is an integer of 1 to 4, B is attached to the backbone of the cellulose ether and selected from O, OC(O), C(O)O, C(O)—NH, NHC(O), S, OSO₃, OPO₃, NH, or NR⁵, wherein R⁵ is a C₂-C₆ acyl or a C₁-C₄ alkyl radical, and X⁻ is an anion.

3. The paper according to claim 1 wherein the cellulose ether has a DS of quaternary ammonium groups of between 0.01 and 0.7.

4. The paper according to claim 1 wherein the cellulose ether further has a DS of carboxymethyl groups of between 0.05 and 1.0.

5. A paper coating comprising cellulose ether wherein the cellulose ether comprises a quaternary ammonium group.

6. The paper according to claim 2 wherein the cellulose ether has a DS of quaternary ammonium groups of between 0.01 and 0.7.

7. The paper according to claim 2 wherein the cellulose ether further has a DS of carboxymethyl groups of between 0.05 and 1.0.

8. The paper coating according to claim 5 wherein said cellulose ether is not a hydroxyethyl cellulose.

9. The paper coating according to claim 8 wherein the quaternary ammonium group is represented by the formula:
(I) 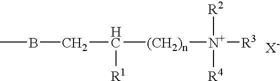
wherein R¹ is H or OH, R², R³, and R⁴are the same or different and are selected from C₁-C₂₄ alkyl, C₆-C₂₄ aryl, C₇-C₂₄ aralkyl, C₇-C₂₄ alkaryl, C₃-C₂₄ cycloalkyl, C₂-C₂₄ alkoxyalkyl, and C₇-C₂₄ alkoxyaryl groups, or R², R³, R⁴, and the quaternary nitrogen atom form an aliphatic or aromatic heterocyclic ring; n is an integer of 1 to 4, B is attached to the backbone of the cellulose ether and selected from O, OC(O), C(O)O, C(O)—NH, NHC(O), S, OSO₃, OPO₃, NH, or NR⁵, wherein R⁵ is a C₂-C₆ acyl or a C₁-C₄ alkyl radical, and X⁻ is an anion.

10. The paper coating according to claim 9 wherein the cellulose ether has a DS of quaternary ammonium groups of between 0.01 and 0.7.

11. The paper coating according to claim 9 wherein the cellulose ether further has a DS of carboxymethyl groups of between 0.05 and 1.0.
